(19) United States
(12) Patent Application Publication
(10) Pub. No.: US 2026/0142814 A1
(43) Pub. Date: May 21, 2026

(54) USER DATA ENCRYPTION BASED ON A USER SUBSCRIPTION

(71) Applicant: T-MOBILE INNOVATIONS LLC, Overland Park, KS (US)

(72) Inventors: Geoffrey Todd Gibson, Rowlett, TX (US); A. Karl Corona, Maple Valley, WA (US); Jean-Luc Rene Bouthemy, Sammamish, WA (US)

(21) Appl. No.: 18/949,784

(22) Filed: Nov. 15, 2024

(51) Int. Cl. H04L 9/32; H04L 65/1069

(52) U.S. Cl. CPC H04L 9/32; H04L 65/1069

(57) ABSTRACT

A data communication system receives a first message from a user communication device that requests a user data session, and in response, determines that the user communication device has a user subscription for encrypted communications. In response to determining that the user communication device has the user subscription for the encrypted communications, the data communication system determines cryptography information for the user data session. The data communication system generates and transfers a second message to the user communication device that indicates the cryptography information for the user data session. The user communication device encrypts user data in response to the cryptography information and transfers the encrypted user data for the user data session. The data communication system generates and transfers a usage record for the user subscription that characterizes the user data session and the user data encryption.

### TECHNICAL BACKGROUND

Wireless communication networks provide wireless data services to wireless communication devices like phones, computers, and other user devices. The wireless data services may include internet-access, user messaging, voice/video calling, or some other data communication product. The wireless communication networks comprise wireless access nodes like Wireless Fidelity (Wi-Fi) hotspots, Fifth Generation New Radio (5G NR) cell towers, and satellites in earth orbit. The wireless communication networks further comprise network elements that process network signaling and handle user data like Access and Mobility Management Functions (AMFs), User Plane Functions (UPFs), and Call Session Control Functions (CSCFs). The wireless communication networks use encryption between the wireless communication devices and the wireless access nodes. The wireless communication networks do not typically continue the encryption beyond their wireless access nodes.

Some wireless communication networks include Internet Protocol Multimedia Subsystems (IMS) that help to deliver the voice calling, video calling, and user messaging services (e.g., Short Messaging Service (SMS), Multimedia Messaging Service (MMS)) to the wireless communication devices. Some IMS use Internet Protocol Security (IPsec) for Session Initiation Protocol (SIP) signaling with the wireless communication devices. IPsec supports device authentication and encryption for the SIP signaling. Cryptographic exchange is provided during SIP IMS registration. Some IMS use integrity protection for the SIP signaling. The IMS do not typically use IPsec to protect user data.

Some wireless communication devices use Real-time Transfer Protocol (RTP) to transfer user data (e.g., voice call, video call). RTP does not include any mechanisms to protect the communications between end points. To secure RTP, wireless communication devices may use Datagram Transport Layer Security (DTLS), Session Description Protocol Security Descriptions (SDES), and IPSec to encrypt RTP user data. DTLS, SDES, and IPSec performs device authentication, cryptographic key exchange, and encryption on the RTP user data which these implementations are known as Secure RTP (SRTP).

Some wireless communication devices use Message Session Relay Protocol (MSRP) to transfer Rich Communication Services (RCS) user messages. The wireless communication devices may use Transport Layer Security (TLS) and Hyper-Text Transfer Protocol Secure (HTTP-S) for the MSRP/RCS messaging. TLS and HTTP-S perform device authentication, cryptographic key exchange, and encryption for the MSRP/RCS messaging.

### TECHNICAL OVERVIEW

In some examples, a method comprises the following operations. Receive a first message from a user communication device that requests a user data session, and in response, determine that the user communication device has a user subscription for encrypted communications. In response to determining that the user communication device has the user subscription for the encrypted communications, determine cryptography information for the user data session. Generate and transfer a second message to the user communication device that indicates the cryptographic information for the user data session. The user communication device encrypts user data in response to the cryptography information and transfers the encrypted user data for the user data session. Generate and transfer a usage record for the user subscription that characterizes the user data session and the user data encryption.

In some examples, a non-transitory computer-readable media stores processing instructions to direct a computer system to perform the following method when the computer system executes the processing instructions. Process an Internet Multimedia Subsystem (IMS) request from a user for a data communication. Determine that the user has a user subscription for encrypted communications and responsively determine cryptography information for the data communication. Generate an IMS response for the user that indicates the cryptography information. The user encrypts user data for the data communication in response to the cryptography information. Generate a usage record for the encrypted communications that characterizes the encryption of the user data in response to the user subscription.

In some examples, a data communication system comprises a Session Initiation Protocol (SIP) system and an application server. The SIP system receives a first SIP message from a user communication device, and in response, determines that the user communication device has a user subscription for encrypted communications. In response to determining that the user communication device has the user subscription for the encrypted communications, the SIP system determines cryptography information. The SIP system generates and transfers a second SIP message to the user communication device that indicates the cryptography information. The user communication device encrypts user data for the data communication in response to the cryptography information. The application server generates and transfers a usage record that characterizes the encryption of the user data.

### DESCRIPTION OF THE DRAWINGS

FIG. 1 illustrates an exemplary data communication system to encrypt user data based on a user subscription for encryption.

FIG. 2 illustrates an exemplary operation of the data communication system to encrypt the user data based on the user subscription for the encryption.

FIG. 3 illustrates an exemplary operation of the data communication system to encrypt the user data based on the user subscription for the encryption.

FIG. 4 illustrates exemplary processing circuitry to encrypt user data based on a user subscription for encryption.

FIG. 5 illustrates an exemplary wireless communication network to encrypt user data and session signaling based on a user subscription for encryption.

FIG. 6 illustrates an exemplary wireless UE in the wireless communication network that encrypts the user data and the session signaling based on the user subscription for the encryption.

FIG. 7 illustrates an exemplary Fifth Generation New Radio (5G NR) Access Node (AN) in the wireless communication network that encrypts the user data and the session signaling based on the user subscription for the encryption.

FIG. 8 illustrates an exemplary Wireless Fidelity (Wi-Fi) AN in the wireless communication network that encrypts the user data and the session signaling based on the user subscription for the encryption.

FIG. 9 illustrates an exemplary Satellite (SAT) AN node and SAT Ground Station (GND) in the wireless communication network that encrypts the user data and the session signaling based on the user subscription for the encryption.

FIG. 10 illustrates an exemplary Network Function Virtualization Infrastructure (NFVI) in the wireless communication network that encrypts the user data and the session signaling based on the user subscription for the encryption.

FIGS. 11-12 illustrate an exemplary operation of the wireless communication network to encrypt the user data and the session signaling for a voice call from a User Equipment (UE) based on the user subscription for the encryption.

FIGS. 13-14 illustrate an exemplary operation of the wireless communication network to encrypt the user data and the session signaling for a voice call to the UE based on the user subscription for the encryption.

FIG. 15 illustrates an exemplary operation of the wireless communication network to encrypt the user data and the session signaling for a user message from the UE based on a user subscription for the encryption. The operation may differ in other examples.

FIG. 16 illustrates an exemplary operation of the wireless communication network to encrypt the user data and the session signaling for a user message to the UE based on a user subscription for the encryption. The operation may differ in other examples.

### DETAILED DESCRIPTION

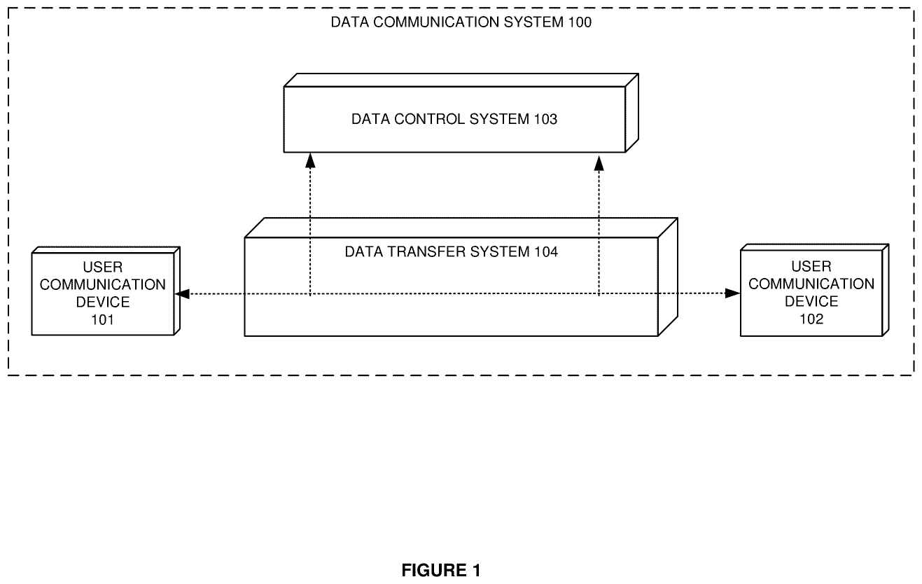

FIG. 1 illustrates exemplary data communication system 100 to encrypt user data based on a user subscription for encryption. Data communication system 100 comprises user communication devices 101-102, data control system 103, and data transfer system 104. User communication devices 101-102 comprise phones, computers, and/or some other user apparatus with data communication components. Data control system 103 comprises an Access and Mobility Management Function (AMF), Uniform Data Management (UDM), Call Session Control Function (CSCF), and/or some other control-plane network elements. Data transfer system 103 comprises a wireless access node, User Plane Function (UPF), Access Gateway (AGW), and/or some other user-plane network elements. The user subscription comprises request from the user for encryption support in exchange for some value. The user subscription may be for one device, a group of devices that share a rate plan, or some other user/device association.

In some examples, data control system 103 receives a message from user communication device 101 that requests a user data session. The user data session comprises an encrypted voice call, encrypted video call, encrypted user data message, or some other encrypted data product. In response to the message, data control system 103 determines that user communication device 101 has the user subscription for encrypted communications. In response to the user subscription, data control system 103 determines cryptography information for the user data session. For example, data control system 103 may determine network addresses for user communication devices, encryption protocol, and integrity protocol that are used to establish and/or transfer encrypted data. Data control system 103 generates and transfers a message to user communication device 101 that indicates the cryptography information for the user data session. User communication device 101 exchanges cryptography messages with user communication device 102 to establish the encryption in response to the cryptography information. User communication device 101 encrypts user data in response to the cryptography information and transfers the encrypted user data for the user data session. Data control system 103 generates and transfers a usage record for the user subscription that characterizes the user data session and the user data encryption. The usage record may indicate network addresses, data type, data amount, data rate, encryption protocol, integrity protocol, date, time, and the like.

An attempt by another device to use the caller identification of wireless communication device 101 is inhibited because the other device could not obtain the cryptography information required to make the improper call attempt. Another wireless communication device that did not have a user subscription for encrypted communications would not receive the cryptography support that was provided to wireless communication device 101. Although the encryption is end-to-end in this example, the encryption could be between wireless communication device and some point in data transfer system 104. In addition, the end-to-end encryption may comprise a set of independently encrypted links that are coupled together to connect user communication devices 101-102.

In some examples, the messages comprise Session Initiation Protocol (SIP) messages. Data control system 103 may comprise a SIP system and/or an Internet Protocol Multimedia Subsystem (IMS). Data control system 103 may determine the cryptography information by exchanging SIP messages with an IMS. The user data may be encrypted by Secure Realtime Transfer Protocol (SRTP) and/or Message Session Relay Protocol (MSRP).

In some examples, data control system 103 develops additional cryptography information for SIP signaling in response to the user subscription. Data control system 103 transfers the additional cryptography information to user communication device 101. User communication device 101 exchanges additional cryptography messages with an IMS to establish the encryption of the SIP signaling in response to the additional cryptography information. User communication device 101 and data control system 103 encrypt the SIP signaling that they exchange in response to the additional cryptography information. Data control system 103 and/or data transfer system 104 generate and transfer usage records that characterize the user data session, the user data encryption, and the SIP signaling encryption.

In some examples, a non-transitory computer-readable media stores processing instructions that direct a computer system to perform the following method when the computer system executes the processing instructions. Process an IMS request from a user for a data communication. Determine that the user has a user subscription for encrypted communications and responsively determine cryptography information for the data communication. Generate an IMS response for the user that indicates the cryptography information. The user encrypts user data for the data communication in response to the cryptography information. Generate a usage record for the user subscription that characterizes the encryption of the user data.

User communication devices 101-102 may wirelessly communicate using wireless protocols like Wireless Fidelity (Wi-Fi), Fifth Generation New Radio (5G NR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. User communication devices 101-102, data control system 103, and data transfer system 104 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

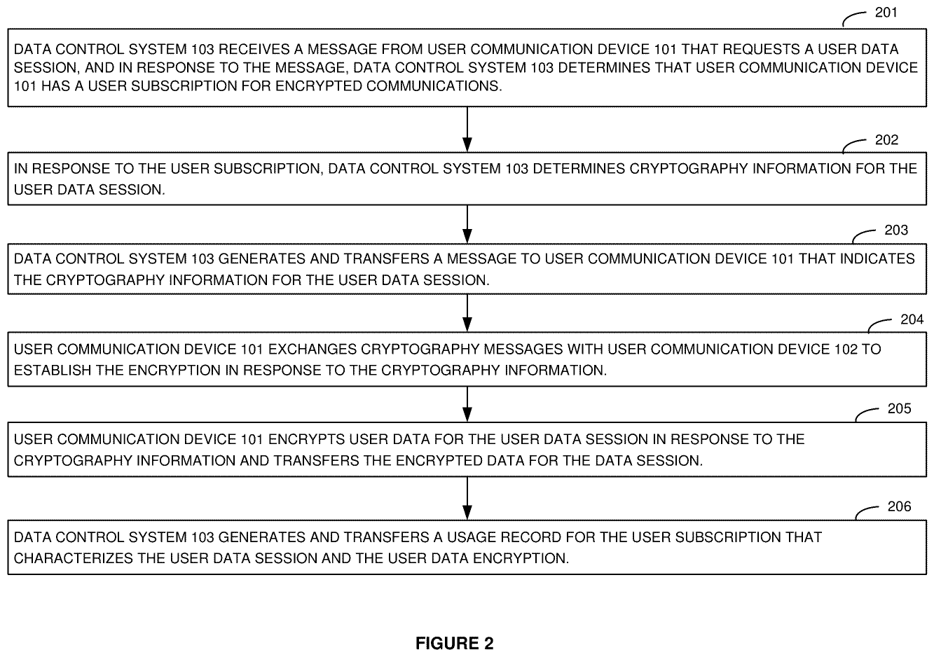

FIG. 2 illustrates an exemplary operation of data communication system 100 to encrypt user data based on the user subscription for the encryption. The operation may differ in other examples. Data control system 103 receives a message from user communication device 101 that requests a user data session, and in response to the message, data control system 103 determines that user communication device 101 has a user subscription for encrypted communications (201). In response to the user subscription, data control system 103 determines cryptography information for the user data session (202). Data control system 103 generates and transfers a message to user communication device 101 that indicates the cryptography information for the user data session (203). User communication device 101 exchanges cryptography messages with user communication device 102 to establish the encryption in response to the cryptography information (204). User communication device 101 encrypts user data for the user data session in response to the cryptography information and transfers the encrypted user data for the user data session (205). Data control system 103 generates and transfers a usage record for the user subscription that characterizes the user data session and the user data encryption (206).

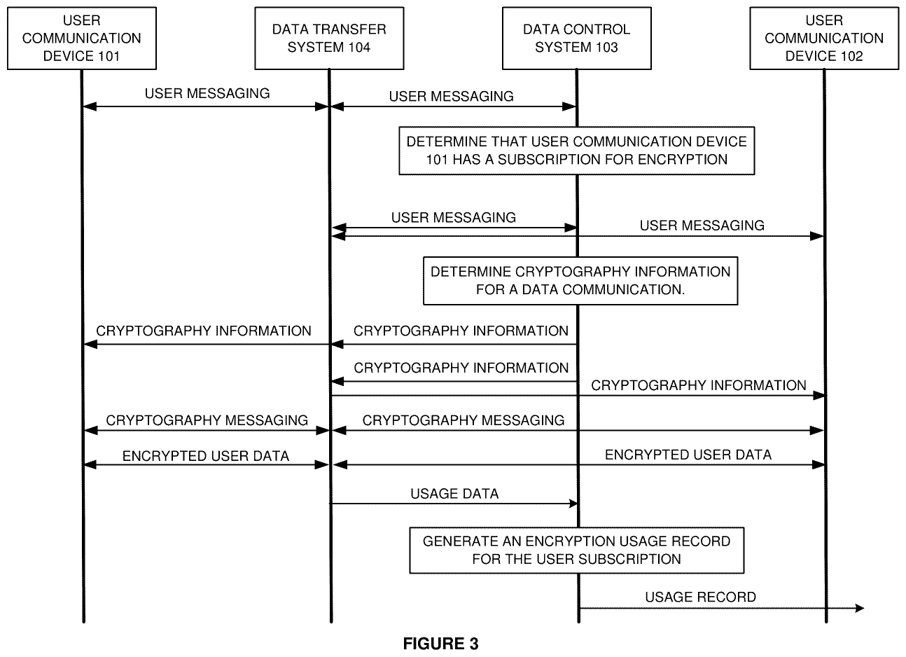

FIG. 3 illustrates an exemplary operation of data communication system 100 to encrypt the user data based on the user subscription for the encryption. The operation may differ in other examples. User communication device 101 and data control system 103 exchange user messaging over data transfer system 104. The user messaging includes a request for a user data session. In response to the user request, data control system 103 determines that user communication device 101 has a user subscription for encrypted communications. In response to the user subscription, data control system 103 exchanges user messaging with user communication device 102 over data transfer system 104 to determine cryptography information like network addresses and encryption protocol. Data control system 103 transfers the cryptography information to user communication devices 101-102 over data transfer system 104. User communication devices 101-102 exchange cryptography messages over data transfer system 104 to establish the encryption in response to the cryptography information. User communication devices 101-102 exchange encrypted user data in response to the cryptography messages. Data control system 103 generates a usage record for the user subscription that characterizes the encryption of the user data. The usage record may indicate wireless communication devices 101-102, encryption protocol, integrity protocol, data amount, data rate, date, and time. Data control system 103 transfers the usage record to a billing system (not shown).

Advantageously, data communication system 100 delivers an individual cryptographic service to wireless communication device 101 and generates usage records for the cryptography service. The excessive cost of providing this cryptographic service to all wireless communication devices is avoided. The usage records enable the collection of value from the subscribing users of the cryptographic service. This collected value can fund further development and growth of the cryptographic service.

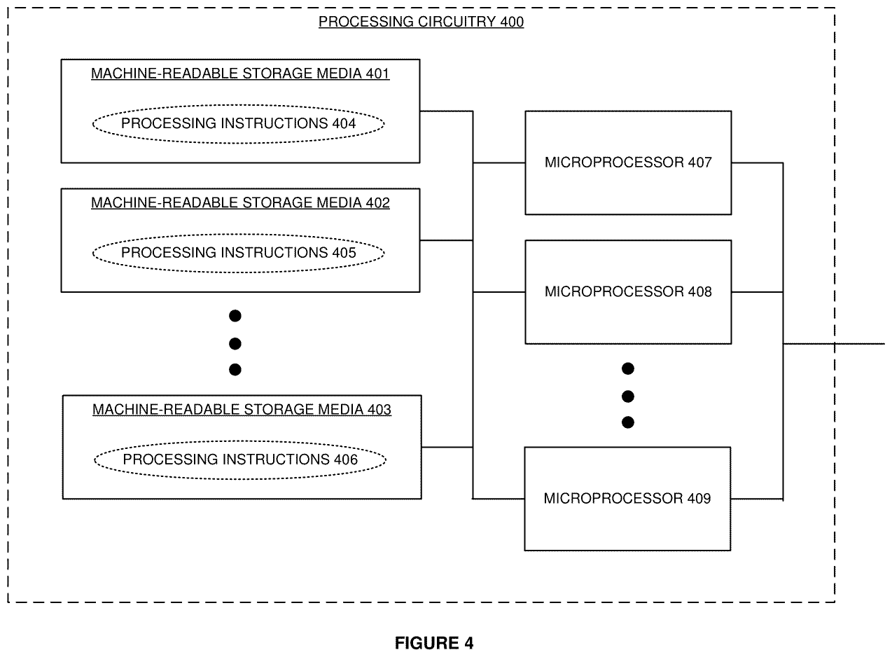

FIG. 4 illustrates exemplary processing circuitry 400 to encrypt user data based on a user subscription for encryption. Processing circuitry 400 comprises an example of user communication devices 101-102, data control system 103, and data transfer system 104, although devices 101-102 and systems 103-104 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to encrypt user data based on a user subscription for encryption as described above for data communication system 100 and as described below for wireless communication network 500. The amount of storage media, microprocessors, processing instructions that are shown in FIG. 4 may vary in other examples.

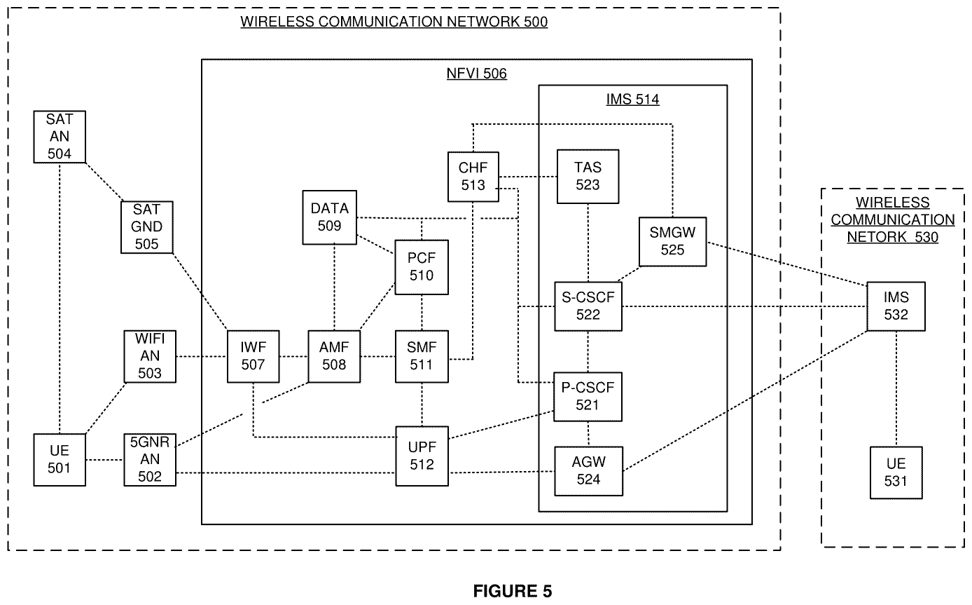

FIG. 5 illustrates exemplary wireless communication network 500 to encrypt user data and session signaling based on a user subscription for encryption. Wireless communication network 500 comprises an example of data communication system 100 and processing circuitry 400, although system 100 and circuitry 400 may differ. Wireless communication network 500 comprises User Equipment (UE) 501, Fifth Generation New Radio (5G NR) Access Node (AN) 502, Wireless Fidelity (Wi-Fi) AN 503, earth satellite (SAT) AN 504, satellite ground station (SAT GND) 505, and Network Function Virtualization Infrastructure (NFVI) 506. NFVI 506 comprises Interworking Function (IWF) 507, Access and Mobility Management Function (AMF) 508, user data system 509, Policy Control Function (PCF) 510, Session Management Function (SMF) 511, User Plane Function (UPF) 512, Charging Function (CHF) 513, and Internet Protocol Multimedia Subsystem (IMS) 514. IMS 514 comprises Proxy Call Session Control Function P-CSCF 521, Serving Call Session Control Function (S-CSCF) 522, Telephony Application Server (TAS) 523, Access Gateway (AGW) 524 and Short Message Gateway (SMGW) 525. User data system 509 comprises a Home Subscriber System (HSS), Unified Data Management (UDM), Uniform Data Repository (UDR), and/or some other network element that handles subscriber information.

S-CSCF 522, AGW 524, and SMGW 525 communicate with IMS 532 in wireless communication network 530. S-CSCF 522 may exchange Session Initiation Protocol (SIP) messages with another S-CSCF in IMS 532. AGW 524 may exchange Real-time Transfer Protocol (RTP) packets with another AGW in IMS 532. SMGW 525 may exchange SIP messages that carry user messages with another SMGW in IMS 532. These network elements may pre-establish encrypted data links that are used for the user subscription as described herein.

Initially, UE 501 attaches to 5G NR AN 502. UE 501 registers with AMF 508 over 5G NR AN 502. AMF 508 retrieves subscriber information for UE 501 from user data system 509. The subscriber information indicates a default bearer between UE 501 and P-CSCF 521. In this example, the default bearer traverses 5G NR AN 502 and UPF 512. In another example, the default bearer traverses Wi-Fi AN 503, IWF 507, and UPF 512. In yet another example, the default bearer traverses SAT AN 504, SAT GNF 505, IWF 507, and UPF 512. UE 501 registers with P-CSCF 521 over the default bearer. P-CSCF 521 and/or S-CSCF 522 retrieve subscriber information for UE 501 from user data system 509. The subscriber information indicates a user subscription for encrypted voice calls, encrypted video calls, and encrypted user messages. The individual subscription may be for UE 501, the user of UE 501, or a subscriber plan that includes UE 501. The subscriber information indicates an encryption requirement that comprises encryption protocols, integrity protocols, encryption and integrity rules, and the like for UE 501. The encryption requirement may indicate how far the encryption should extend from UE 501 and how calls with non-supporting UEs are handled. P-CSCF 521 indicates the encryption requirement to UE 501 and S-CSCF 522. In response to the encryption requirement, P-CSCF 521 and UE 501 establish encryption over the default bearer.

For a voice call from UE 501 to UE 531, UE 501 transfers an encrypted SIP INVITE for UE 531 to P-CSCF 521 over the default bearer. P-CSCF 521 decrypts and processes the SIP INVITE. P-CSCF 521 encrypts and transfers the SIP INVITE for UE 531 to S-CSCF 522. S-CSCF 522 decrypts and processes the SIP INVITE. S-CSCF 522 invokes TAS 523 for the voice call. In response to the encryption requirement, S-CSCF 522 encrypts and transfers the SIP INVITE for UE 531 to IMS 532. S-CSCF 522 may already have an encrypted SIP link to IMS 532. Alternatively, S-CSCF 522 may dynamically establish an encrypted SIP link with IMS 532 for a SIP session. S-CSCF 522 may drop the call attempt if IMS 532 does not comply. S-CSCF 522 may obtain user permission for an unencrypted call attempt if IMS 532 does not comply. IMS 532 decrypts and processes the SIP INVITE for UE 531. IMS 532 encrypts and transfers the SIP INVITE to UE 531. IMS 532 may already have an encrypted SIP link to UE 531 or IMS 532 may dynamically establish an encrypted SIP link to UE 531 for a SIP session. IMS 532 may drop the call attempt or obtain user permission for an unencrypted call attempt if UE 531 does not comply.

UE 531 accepts the voice call and returns an encrypted SIP response that indicates call acceptance and its current internet address to IMS 532. IMS 532 decrypts and processes the SIP response. IMS 532 encrypts and transfers the SIP response to S-CSCF 522. S-CSCF 522 decrypts and processes the SIP response. S-CSCF 522 invokes TAS 523 for call control. S-CSCF 522 encrypts and transfers the SIP response to P-CSCF 521. P-CSCF 521 decrypts and processes the SIP response. P-CSCF 521 encrypts and transfers the SIP response to UE 501.

TAS 523 directs S-CSCF 522 to establish a voice bearer for UE 501. S-CSCF 522 directs P-CSCF 521 to establish the voice bearer for UE 501. P-CSCF 524 signals AGW 524 to deliver the voice bearer between UPF 512 and IMS 532. P-CSCF 521 directs PCF 510 to establish the voice bearer for UE 501. PCF 510 directs SMF 511 to establish the voice bearer for UE 501. SMF 511 directs AMF 508 to establish the voice bearer. AMF 508 signals 5G NR AN 502 to deliver the voice bearer between UE 501 and UPF 512. AMF 508 signals SMF 511 to deliver the voice bearer between 5G NR AN 502 and AGW 524. SMF 511 signals UPF 512 to deliver the voice bearer between 5G NR AN 502 and AGW 524. Reciprocal operations by IMS 532 and wireless communication network 530 establish the voice bearer between AGW 524 and UE 531—typically through an AGW in IMS 532. In response to the encryption requirement, UE 501 and UE 531 establish an encrypted RTP link over 5G NR AN 502, UPF 512, AGW 524, IMS 532, and network 530. UE 501 and UE 531 exchange encrypted voice RTP packets over this encrypted RTP link. S-CSCF 522 reports the cryptography usage for the voice call to TAS 523.

UPF 512 determines network usage for the call and transfers the usage information to SMF 511. The network usage data indicates UE 501, date and time, and amount of voice data. SMF 511 generates a rough Call Detail Record (CDR) based on the network usage data. SMF 511 transfers the rough CDR to CHF 513. TAS 523 determines cryptography usage for the call. The cryptography usage indicates UE 501, UE 531, date and time, and encryption details like encryption protocol and integrity protection. TAS 523 generates a rough CDR based on the cryptography usage. TAS 523 transfers the rough CDR to CHF 513 or to a billing system (not shown) where the rough CDRs are merged into a single CDR that indicates network usage and encryption details for the voice call.

For a voice call from UE 531 to UE 501, UE 501 transfers a SIP invite to IMS 532 which transfers the SIP INVITE to S-SCSF 522. S-CSCF 522 receives the SIP INVITE for UE 501 from IMS 532. In response to the encryption requirement, S-CSCF 522 may require the encryption of SIP signaling by UE 531 and IMS 532 before proceeding. S-CSCF 522 may obtain user approval for the unencrypted SIP signaling before proceeding. To proceed, S-CSCF 522 decrypts and processes the INVITE 522 to invoke TAS 523. S-CSCF 522 encrypts and transfers the SIP INVITE to P-CSCF 521. P-CSCF 521 decrypts and processes the SIP INVITE. P-CSCF 521 encrypts and transfers the SIP INVITE to UE 501 over the default bearer. UE 501 decrypts the SIP INVITE and accepts the call by returning an encrypted SIP response to P-CSCF 521 that has the internet address for UE 501. P-CSCF 521 decrypts and processes the SIP response. P-CSCF 521 encrypts and transfers the SIP response to S-CSCF 522. S-CSCF 522 decrypts and processes the SIP response. S-CSCF 522 invokes TAS 523. S-CSCF 522 encrypts and transfers the SIP response to IMS 532. IMS 532 decrypts and processes the SIP response. IMS 532 encrypts and transfers the SIP response to UE 531. UE 531 decrypts and processes the SIP response.

TAS 523 directs S-CSCF 522 to establish a voice bearer for UE 501. S-CSCF 522 directs P-CSCF 521 to establish the voice bearer for UE 501. P-CSCF 524 signals AGW 524 to deliver the voice bearer between UPF 512 and IMS 532. P-CSCF 521 directs PCF 510 to establish a voice bearer for UE 501. PCF 510 directs SMF 511 to establish the voice bearer. SMF 511 directs AMF 508 to establish the voice bearer for UE 501. AMF 508 signals 5G NR AN 502 to deliver the voice bearer between UE 501 and UPF 512. AMF 508 signals SMF 511 to deliver the voice bearer between 5G NR AN 502 and AGW 524. SMF 511 signals UPF 512 to deliver the voice bearer between 5G NR AN 502 and AGW 524. Reciprocal operations by IMS 532 and wireless communication network 530 establish the voice bearer between AGW 524 and UE 531. In response to the encryption requirement, UE 501 and UE 531 establish an encrypted RTP link over 5G NR AN 502, UPF 512, AGW 524, IMS 532, and network 530. UE 501 and UE 531 exchange encrypted voice RTP packets over this encrypted RTP link. S-CSCF 522 reports the encryption details to TAS 523.

UPF 512 determines network usage for the call and transfers the usage information to SMF 511. The network usage information indicates UE 501, date and time, and amount of voice data. SMF 511 generates a rough CDR based on the network usage information. SMF 511 transfers the rough CDR to CHF 513. TAS 523 determines cryptography usage for the call and transfers cryptography usage information to CHF 513. The cryptography usage information indicates UE 501, UE 531, date and time, and encryption details. TAS 523 generates a rough CDR based on the cryptography usage information. TAS 523 transfers the rough CDR to CHF 513 or to a billing system (not shown) where the CDRs are merged into a single CDR that indicates network usage and encryption details for the voice call.

Wireless communication networks 500 and 530 operate in a similar manner to deliver encrypted video calls between UE 501 and UE 531. For video calls, the encrypted RTP packets would carry user video and user audio.

To transfer a user message like a text or a picture to UE 531, UE 501 transfers an encrypted SIP message that carries the user message to P-CSCF 521 over the default bearer. P-CSCF 521 decrypts and processes the SIP message. P-CSCF 521 encrypts and transfers the SIP message for UE 531 to S-CSCF 522. S-CSCF 522 decrypts and processes the SIP message. S-CSCF 522 encrypts and transfers the SIP message for UE 531 to SMGW 525. SMGW 525 may already have an encrypted SIP link to IMS 532 or SMGW 525 may establish an encrypted SIP link for a SIP session. SMGW 525 may drop the user message if IMS 532 does not comply. SMGW 525 may obtain user approval to continue with unencrypted messaging if IMS 532 does not comply. SMGW 522 transfers the encrypted SIP message to IMS 532. IMS 532 decrypts and processes the SIP message for UE 531. IMS 532 encrypts and transfers the encrypted SIP message to UE 531. IMS 532 may already have an encrypted SIP link to UE 531 or may establish an encrypted SIP link for a SIP session. IMS 532 may drop the user message or obtain user approval for an unencrypted message if UE 531 does not comply. IMS 532 encrypts and transfers the SIP message to UE 531. UE 531 decrypts the SIP message and presents the user message.

UPF 512 determines network usage for the user message and transfers the usage information to SMF 511. The network usage data indicates UE 501, date and time, and amount of SIP/user messaging. SMF 511 generates a rough CDR based on the network usage data. SMF 511 transfers the rough CDR to CHF 513. SMGW 525 determines cryptography usage for the user message and transfers cryptography usage information to CHF 513. The cryptography usage information indicates UE 501, UE 531, date and time, and encryption details. SMGW 525 generates a rough CDR based on the cryptography usage information. SMGW 525 transfers the rough CDR to CHF 513 or to a billing system (not shown) where the CDRs are merged into a single CDR that indicates network usage and encryption details for the user message.

For a user message from UE 531 to UE 501, UE 501 transfers a SIP message that carries the user message to IMS 532. IMS 532 transfers the SIP message to SMGW 525. SMGW 525 receives the SIP message for UE 501 from IMS 532. In response to the encryption requirement, SMGW 525 may discard any unencrypted SIP messages or may obtain user consent for unencrypted SIP messaging before proceeding. SMGW 525 decrypts and processes the SIP message. SMGW 525 encrypts and transfers the SIP message to S-CSCF 522. S-CSCF 522 decrypts and processes the SIP message. S-CSCF 522 encrypts and transfers the SIP message to P-CSCF 521. P-CSCF 521 decrypts and processes the SIP message. P-CSCF 521 encrypts and transfers the SIP message to UE 501 over the default bearer. UE 501 decrypts the SIP message and presents the user message.

UPF 512 determines network usage for the call and transfers the usage information to SMF 511. The network usage data indicates UE 501, date and time, and amount of SIP messaging. SMF 511 generates a rough CDR based on the network usage data. SMF 511 transfers the rough CDR to CHF 513. SMGW 525 determines cryptography usage for the user message and transfers cryptography usage information to CHF 513. The cryptography usage information indicates UE 501, UE 531, date and time, and encryption details. SMGW 525 generates a rough CDR based on the cryptography usage information. SMGW 525 transfers the rough CDR to CHF 513 or to a billing system (not shown) where the CDRs are merged into a single CDR that indicates network usage and encryption details for the user message.

In alternative examples, UE 501 attaches to Wi-Fi AN 503 and registers with AMF 508 over IWF 507. The default bearer between UE 501 and P-CSCF 521 would traverse Wi-Fi AN 503, IWF 507, and UPF 512. The RTP link between UE 501 and UE 531 would traverse Wi-Fi AN 503, IWF 507, UPF 512, AGW 524, and IMS 532. In other alternative examples, UE 501 attaches to SAT AN 504 and registers with AMF 508 over SAT AN 504, SAT GND 505, and IWF 507. The default bearer between UE 501 and P-CSCF 521 would traverse SAT AN 504, SAT GND 505, IWF 507, and UPF 512. The RTP link between UE 501 and UE 531 would traverse SAT AN 504, SAT GND 505, IWF 507, UPF 512, AGW 524, and IMS 532. Various combinations of 5G NR, Wi-Fi, and satellite access may be used for the SIP signaling and the RTP packets.

An attempt by another UE to use the caller identification of UE 501 is inhibited because the other UE could not obtain the cryptography information from P-CSCF 521 that is required to make the call attempt. Another UE that did not have a user subscription for encrypted communications would not receive the cryptography support that was provided to UE 501. Although the encryption is end-to-end in these examples, the encryption could be between UE 501 and AGW 524, IMS 532, or some other point. In addition, the end-to-end encryption may comprise a set of independently encrypted links like: UE 501 to AGW 524, AGW 524 to IMS 532, and IMS 532 to UE 531.

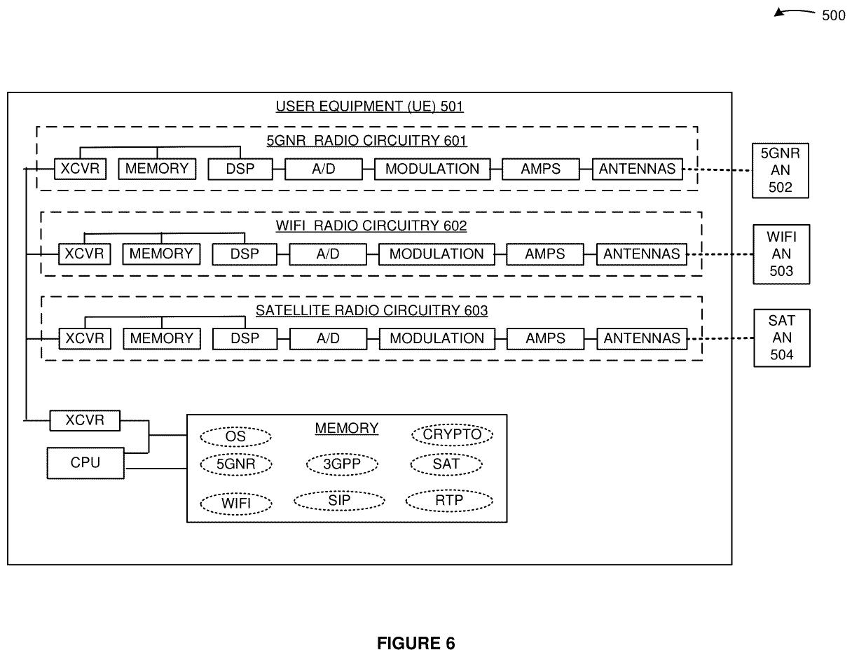

FIG. 6 illustrates exemplary wireless UE 501 in wireless communication network 500 that encrypts the user data and the session signaling based on the user subscription for the encryption. UE 501 comprises an example of wireless communication devices 101-102, processing circuitry 400, and UE 531, although devices 101-102, circuitry 400, and UE 531 may differ. UE 501 comprises Fifth Generation New Radio (5G NR) radio circuitry 601, Wireless Fidelity (Wi-Fi) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5G NR Application (5G NR), 3GPP Application (3GPP), Wi-Fi Application (Wi-Fi), Satellite Application (SAT), Cryptography Application (CRYPTO), and RTP Application (RTP). The antennas in radio circuitry 601-603 exchange wireless signals with ANs 502-504. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

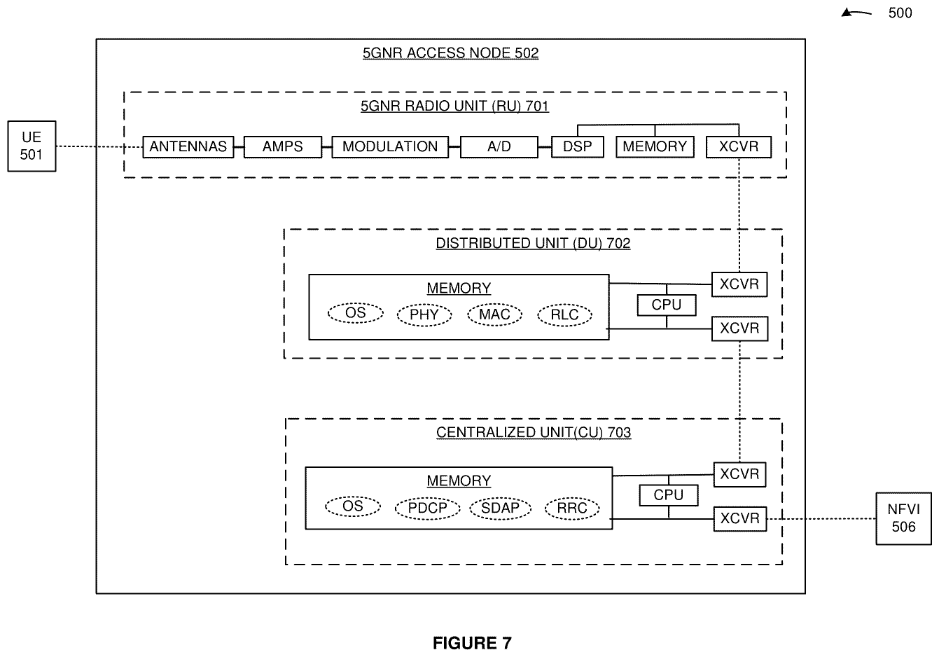

FIG. 7 illustrates exemplary Fifth Generation New Radio (5G NR) Access Node (AN) 502 in wireless communication network 500 that encrypts the user data and the session signaling based on the user subscription for the encryption. 5G NR AN 502 comprises an example of data control system 103, data transfer system 104, and processing circuitry 400, although systems 103-104 and circuitry 400 may differ. 5G NR AN 502 comprises 5G NR Radio Unit (RU) 701, Distributed Unit (DU) 702, and Centralized Unit (CU) 703. 5G NR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5G NR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5G NR network applications for Packet Data Convergence Protocol (PDCP), Service Data Adaption Protocol (SDAP), and Radio Resource Control (RRC). The antennas in 5G NR RU 701 are wirelessly coupled to UE 501 over 5G NR links. Transceivers in 5G NR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein.

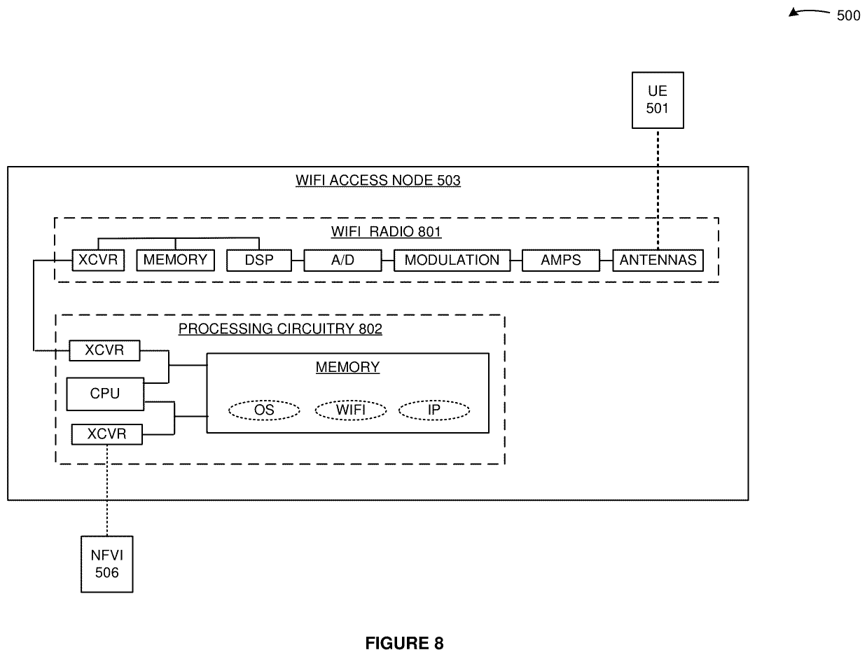

FIG. 8 illustrates exemplary Wireless Fidelity (Wi-Fi) AN 503 in wireless communication network 500 that encrypts the user data and the session signaling based on the user subscription for the encryption. Wi-Fi AN 503 comprises an example of data control system 103, data transfer system 104, and processing circuitry 400, although systems 103-104 and circuitry 400 may differ. Wi-Fi AN 503 comprises Wi-Fi radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), Wi-Fi application (Wi-Fi), and IP application (IP). The antennas in Wi-Fi radio 801 exchange Wi-Fi signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein.

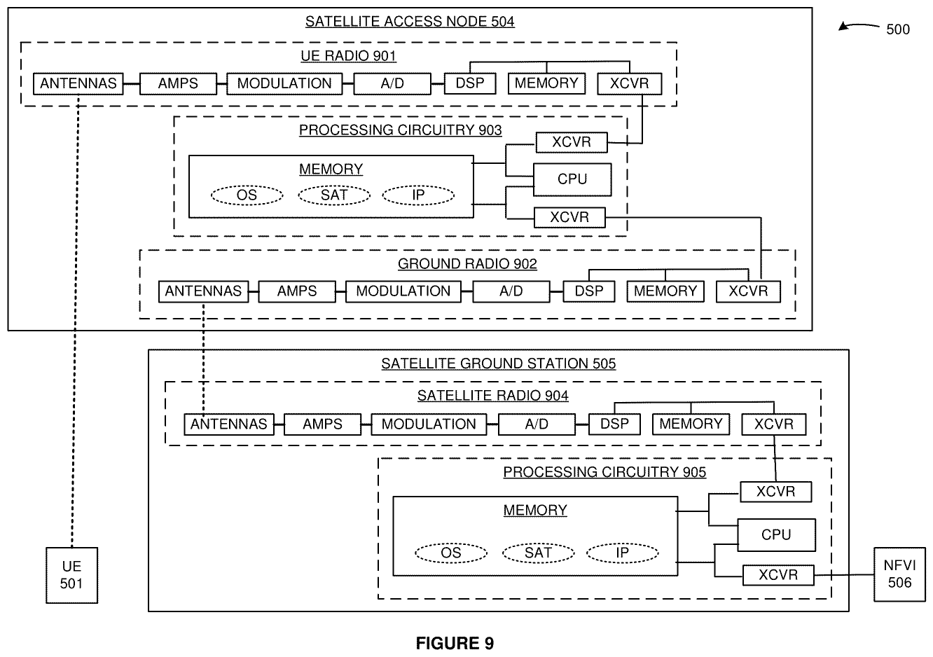

FIG. 9 illustrates exemplary Satellite (SAT) AN 504 and SAT Ground Station (GND) 505 in wireless communication network 500 that encrypts the user data and the session signaling based on the user subscription for the encryption. SAT AN 504 and SAT GND 505 comprises an example of data control system 103, data transfer system 104, and processing circuitry 400, although systems 103-104 and circuitry 400 may differ. SAT AN 504 comprises UE radio 901, ground radio 902 and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UE 501 and NFVI 506 as described herein.

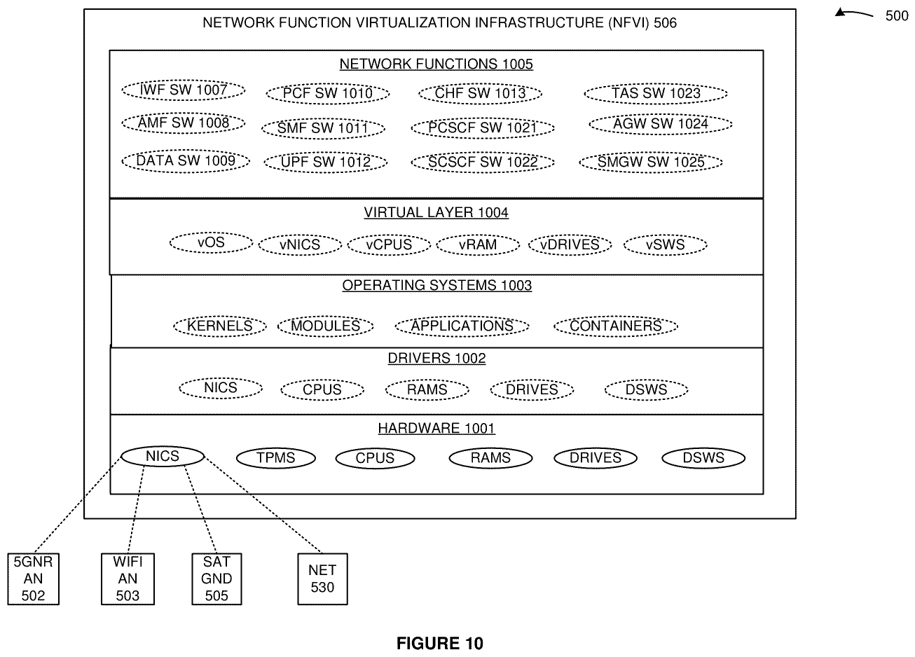

FIG. 10 illustrates exemplary Network Function Virtualization Infrastructure (NFVI) 506 in wireless communication network 500 that encrypts the user data and the session signaling based on the user subscription for the encryption. NFVI 506 comprises an example of data control system 103, data transfer system 104, and processing circuitry 400, although systems 103-104 and circuitry 400 may differ. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises IWF SW 1007, AMF SW 1008, HSS/UDM/UDR SW 1009, PCF SW 1009, SMF SW 1011, UPF SW 1012, CHF SW 1013, P-CSCF SW 1021, S-CSCF SW 1022, TAS SW 1023, AGW SW 1024, and SMGW SW 1025. The NICS in hardware 1001 are coupled to ANs 502-503, SAT GND 505, and network 530. Hardware 1001 executes hardware drivers 1002, operating systems 1003, virtual layer 1004, and network functions 1005 to form and operate IWF 507, AMF 508, user data system 509, PCF 510, SMF 511, UPF 512, P-CSCF 521, S-CSCF 522, TAS 523, AGW 524, and SMGW 525 as described herein. NFVI 506 may be located at a single site or be distributed across multiple geographic areas.

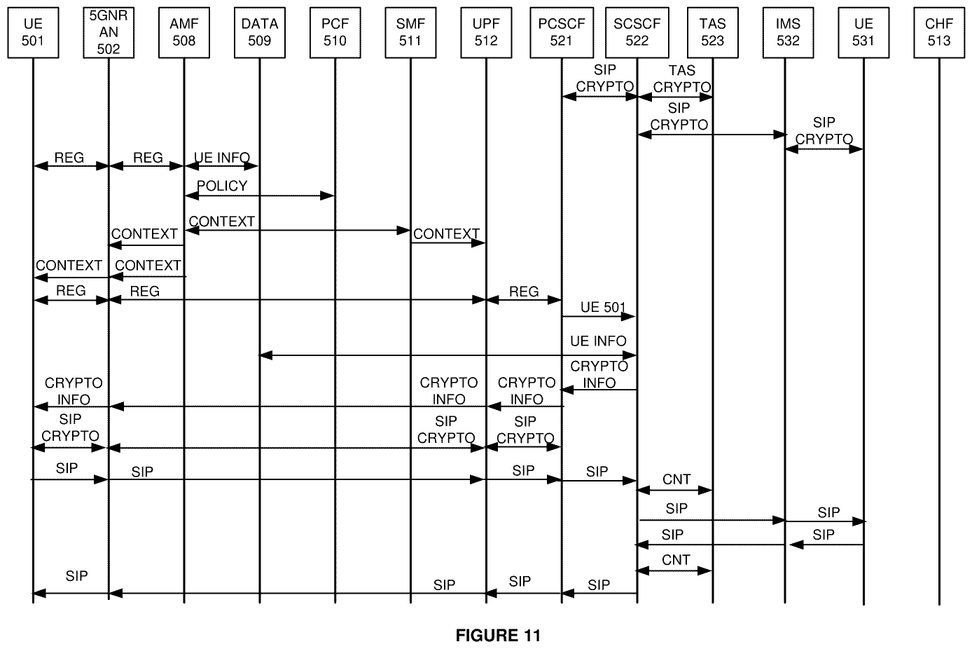

FIG. 11 illustrates an exemplary operation of wireless communication network 500 to encrypt the user data and the session signaling for a voice call from UE 501 to UE 531 based on the user subscription for the encryption. The operation may differ in other examples. Initially, P-CSCF 521 and S-CSCF 522 exchange cryptography information to establish an encrypted SIP link. S-CSCF 522 and TAS 523 exchange cryptography information to establish an encrypted TAS link. S-CSCF 522 and IMS 532 exchange cryptography information to establish an encrypted SIP link. IMS 532 and UE 531 exchange cryptography information to establish an encrypted SIP link—typically in the manner of UE 501 and P-CSCF 521. UEs with user subscriptions for encryption get to use these encrypted links, while UEs that do not have the user subscriptions for the encryption do not get to use these encrypted links.

UE 501 registers with AMF 508 over 5G NR AN 502. AMF 508 retrieves subscriber information for UE 501 from user data system 509. The subscriber information indicates a default bearer between UE 501 and P-CSCF 521. AMF 508 obtains policy for UE 501 from PCF 810. AMF 508 and SMF 511 process the subscriber information and policy to develop UE context. AMF 508 transfers the UE context to 5G NR AN 502. SMF 511 transfers the UE context to UPF 512. AMF 508 transfers the UE context to UE 501 over 5G NR AN 502. The default bearer traverses 5G NR AN 502 and UPF 512. UE 501 registers with P-CSCF 521 over the default bearer. P-CSCF 521 notifies S-CSCF 522 of UE 501. S-CSCF 522 retrieves subscriber information for UE 501 from user data system 509. The subscriber information indicates an individual subscription for encrypted voice calls and cryptography instructions for UE 501. S-CSCF 522 indicates the cryptography instructions for UE 501 to P-CSCF 521. P-CSCF 521 indicates the cryptography instructions to UE 501 over the default bearer that traverses UPF 512 and 5G NR AN 502. In response to the cryptography instructions, P-CSCF 521 and UE 501 exchange SIP cryptography data to establish IP encryption over the default bearer.

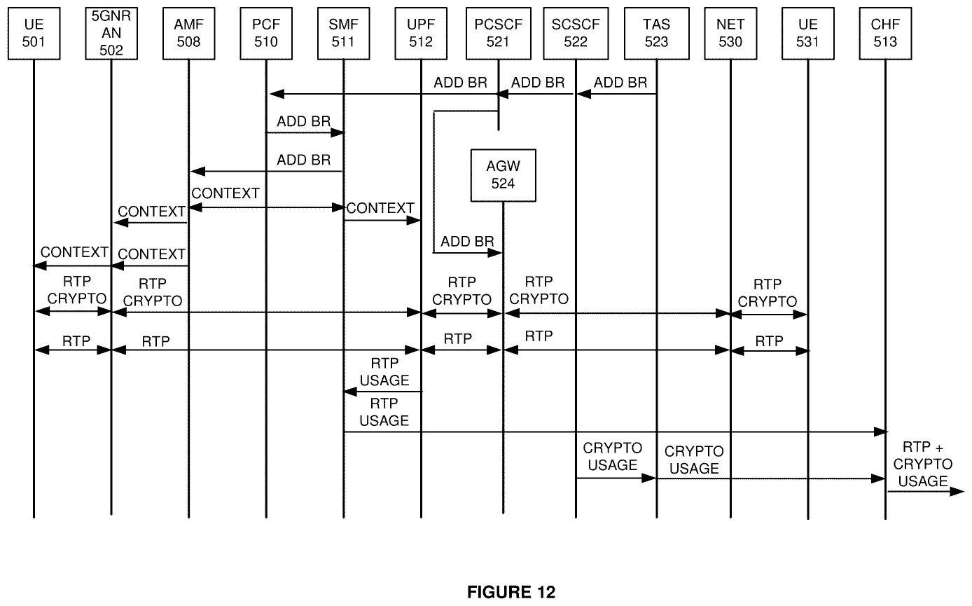

For the voice call from UE 501 to UE 531, UE 501 encrypts and transfers a SIP INVITE for UE 531 to P-CSCF 521 over the default bearer. P-CSCF 521 decrypts and processes the SIP INVITE. P-CSCF 521 encrypts and transfers the SIP INVITE to S-CSCF 522. S-CSCF 522 decrypts and processes the SIP INVITE. S-CSCF 522 invokes TAS 523 for call control (CNT). In response to the cryptography instructions, S-CSCF 522 encrypts and transfers the SIP INVITE for UE 531 to IMS 532. IMS 532 decrypts and processes the SIP INVITE for UE 531. In response to use of the encrypted link with S-CSCF 522, IMS 532 encrypts and transfers the SIP INVITE to UE 531. UE 531 accepts the voice call and returns an encrypted SIP response that indicates call acceptance and the internet address for UE 531. IMS 532 decrypts and processes the encrypted SIP response. IMS 532 encrypts and transfers the encrypted SIP response to S-CSCF 522. S-CSCF 522 decrypts and processes the encrypted SIP response. S-CSCF 522 invokes TAS 523 for call control. S-CSCF 522 encrypts and transfers the encrypted SIP response to P-CSCF 521. P-CSCF 521 decrypts and processes the encrypted SIP response. P-CSCF 521 encrypts and transfers the encrypted SIP response to UE 501 over the default bearer. The operation continues on FIG. 12.

FIG. 12 further illustrates an exemplary operation of wireless communication network 500 to encrypt the user data and the session signaling for the voice call from UE 501 to UE 531 based on the user subscription for the encryption. The operation continues from FIG. 11 and may differ in other examples. In response to the call acceptance indicated by the SIP messaging, P-CSCF 521 directs PCF 510 to add the voice bearer. P-CSCF 521 instructs AGW 524 to add the voice bearer. PCF 510 directs SMF 511 to add the voice bearer. SMF 511 directs AMF 508 to add the voice bearer. AMF 508 and SMF 511 interact to develop context for the voice bearer like internet addresses and quality-of-service. SMF 511 transfers the context to UPF 512. AMF 508 transfers the context to 5G NR AN 502. AMF 508 transfers the context to UE 501 over 5G NR AN 502. AMF 508 transfers the context to 5G NR AN 502. In response to the cryptography information, UE 501 and UE 531 exchange RTP cryptography data to establish an encrypted RTP link over 5G NR AN 502, UPF 512, AGW 524, IMS 532, and network 530. UE 501 and UE 531 exchange encrypted RTP voice packets over this RTP link.

UPF 512 determines RTP usage for the call and transfers RTP usage information to SMF 511. The RTP usage information indicates UE 501, date and time, and amount of RTP data. SMF 511 generates a rough CDR based on the RTP usage data. SMF 511 transfers the rough CDR to CHF 513. S-CSCF 522 determines cryptography usage for the call and transfers cryptography usage information to TAS 523. The cryptography usage information indicates UE 501, UE 511, date and time, and encryption details. TAS 523 generates a rough CDR based on the cryptography usage information and transfers the rough CDR to CHF 513. CHF 513 merges the rough CDRs into a single CDR that indicates the RTP usage and cryptography usage for the voice call. CHF 513 transfers the single CDR to a billing system (not shown).

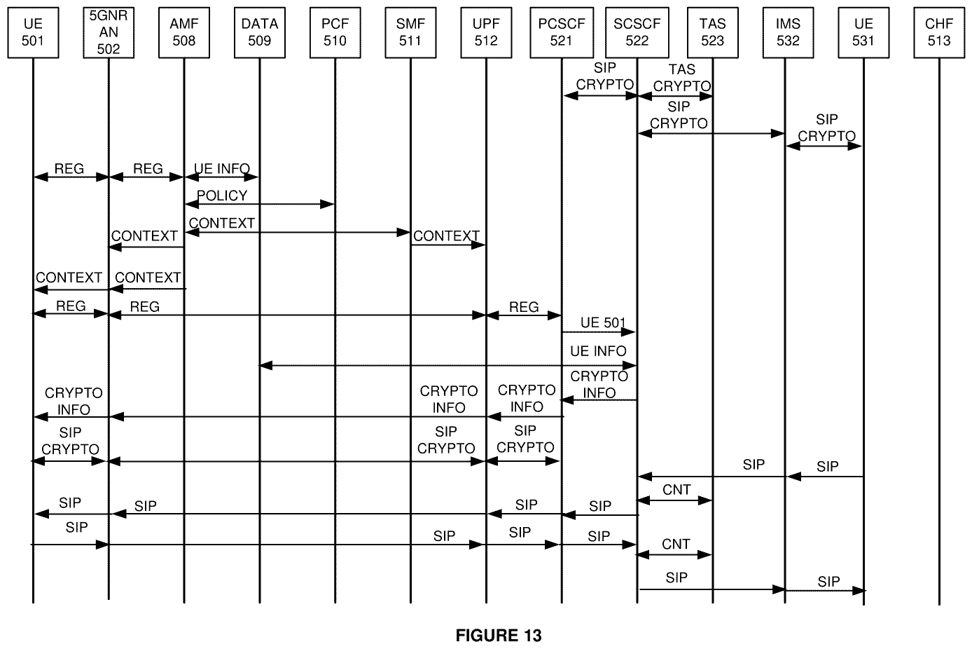

FIG. 13 illustrates an exemplary operation of wireless communication network 500 to encrypt the user data and the session signaling for a voice call from UE 531 to UE 501 based on the user subscription for the encryption. The operation may vary in other examples. Initially, P-CSCF 521 and S-CSCF 522 exchange cryptography information to establish an encrypted SIP link. S-CSCF 522 and TAS 523 exchange cryptography information to establish an encrypted TAS link. S-CSCF 522 and IMS 532 exchange cryptography information to establish an encrypted SIP link. IMS 532 and UE 531 exchange cryptography information to establish an encrypted SIP link. UEs with user subscriptions for encryption get to use these encrypted links, while UEs that do not have the user subscriptions for the encryption do not get to use these encrypted links.

UE 501 registers with AMF 508 over 5G NR AN 502. AMF 508 retrieves subscriber information for UE 501 from user data system 509. The subscriber information indicates a default bearer between UE 501 and P-CSCF 521. AMF 508 obtains policy for UE 501 from PCF 810. AMF 508 and SMF 511 process the subscriber information and policy to develop UE context. AMF 508 transfers the UE context to 5G NR AN 502. SMF 511 transfers the UE context to UPF 512. AMF 508 transfers the UE context to UE 501 over 5G NR AN 502. The default bearer traverses 5G NR AN 502 and UPF 512. UE 501 registers with P-CSCF 521 over the default bearer. P-CSCF 521 notifies S-CSCF 522 of UE 501. S-CSCF 522 retrieves subscriber information for UE 501 from user data system 509. The subscriber information indicates an individual subscription for encrypted voice calls and cryptography instructions for UE 501. S-CSCF 522 the indicates cryptography instructions for UE 501 to P-CSCF 521. P-CSCF 521 indicates the cryptography instructions to UE 501 over the default bearer that traverses UPF 512 and 5G NR AN 502. In response to the cryptography instructions, P-CSCF 521 and UE 501 exchange cryptography data to establish SIP encryption over the default bearer.

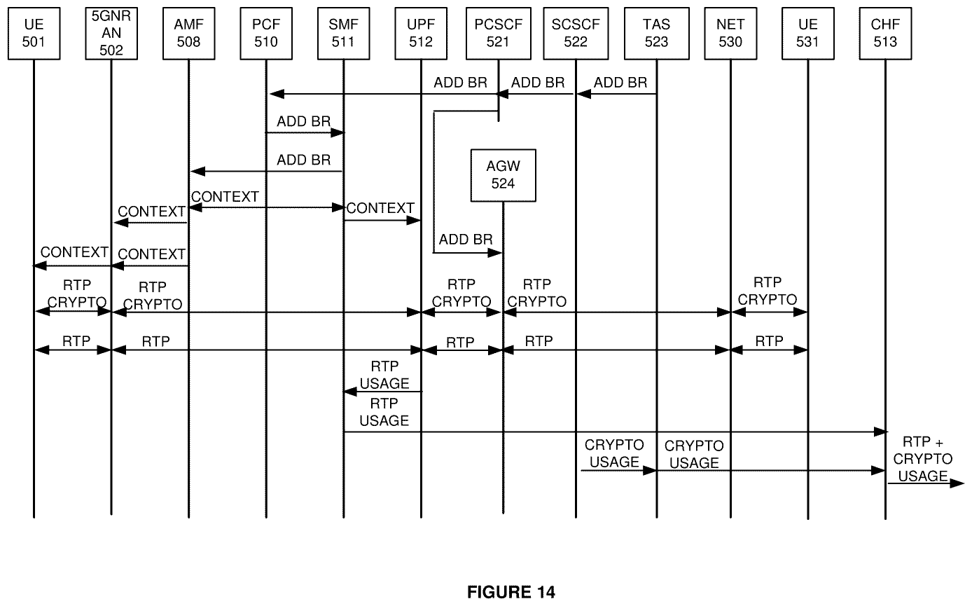

For a voice call from UE 531 to UE 501, UE 531 transfers an encrypted SIP invite to IMS 532 which transfers the encrypted SIP INVITE to S-SCSF 522. S-CSCF 522 decrypts and processes the SIP INVITE for UE 501 from IMS 532. S-CSCF 522 invokes TAS 523 for call control. S-CSCF 522 encrypts and transfers the SIP INVITE to P-CSCF 521. P-CSCF 521 decrypts and processes the SIP INVITE. P-CSCF 521 encrypts and transfers the SIP INVITE to UE 501 over the default bearer. UE 501 decrypts the SIP INVITE and accepts the call by returning an encrypted SIP response to P-CSCF 521 that has the internet address for UE 501. P-CSCF 521 decrypts and processes the SIP response. P-CSCF 521 encrypts and transfers the SIP response to S-CSCF 522. S-CSCF 522 decrypts and processes the SIP response. S-CSCF 522 invokes TAS 523. S-CSCF 522 encrypts and transfers the SIP response to IMS 532. IMS 532 decrypts and processes the SIP response. IMS 532 encrypts and transfers the SIP response to UE 531. UE 531 decrypts and processes the SIP response. The operation continues with FIG. 14.

FIG. 14 illustrates the exemplary operation of wireless communication network 500 to encrypt the user data and the session signaling for the voice call to UE 501 based on the user subscription for the encryption. The operation follows from FIG. 13 and may vary in other examples. In response to the SIP messaging, P-CSCF 521 directs PCF 510 to establish the voice bearer. P-CSCF 521 directs AGW 524 to add the voice bearer. P-CSCF 521 directs PCF 510 to add the voice bearer between UE 501 and AGW 524. PCF 510 directs SMF 511 to establish the voice bearer. SMF 511 directs AMF 508 to establish the voice bearer. AMF 508 signals 5G NR AN 502 to deliver the voice bearer between UE 501 and UPF 512. AMF 508 signals SMF 511 to deliver the voice bearer between 5G NR AN 502 and AGW 524. SMF 511 signals UPF 512 to deliver the voice bearer between 5G NR AN 502 and AGW 524. Reciprocal operations by IMS 532 and wireless communication network 530 establish the voice bearer between AGW 524 and UE 531—typically over another AGW in IMS 432. In response to the cryptography information, UE 501 and UE 531 exchange RTP cryptography data to establish an encrypted RTP link over 5G NR AN 502, UPF 512, AGW 524, IMS 532, and network 530. UE 501 and UE 531 exchange encrypted voice RTP packets over this encrypted RTP link.

UPF 512 determines RTP usage for the call and transfers the RTP usage information to SMF 511. The RTP usage information indicates UE 501, date and time, and amount of voice data. SMF 511 generates a rough CDR based on the RTP usage. SMF 511 transfers the rough CDR to CHF 513. TAS 523 generates a rough CDR based on the cryptographic usage. TAS 523 transfers the rough CDR to CHF 513 or to a billing system (not shown) where the CDRs are merged into a single CDR that indicates RTP usage and cryptographic usage for the voice call.

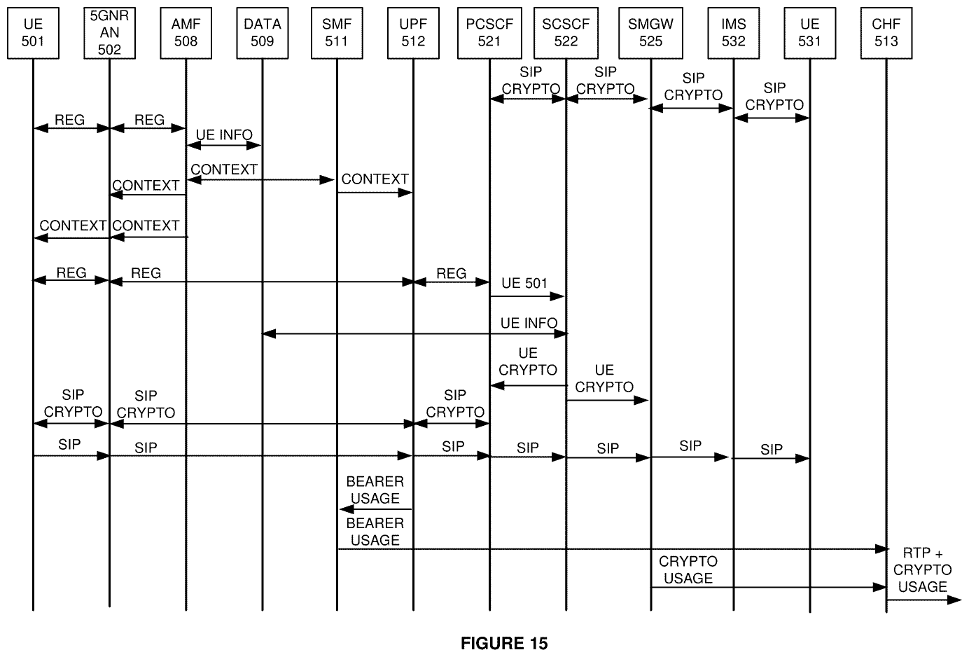

FIG. 15 illustrates an exemplary operation of wireless communication network 500 to encrypt the user data and the session signaling for a user message from UE 501 to UE 531 based on a user subscription for the encryption. The operation may differ in other examples. Initially, P-CSCF 521 and S-CSCF 522 exchange cryptography information to establish an encrypted SIP link. S-CSCF 522 and SMGW 525 exchange cryptography information to establish an encrypted SIP link. SMGW 525 and IMS 532 exchange cryptography information to establish an encrypted SIP link. IMS 532 and UE 531 exchange cryptography information to establish an encrypted SIP link. UEs with user subscriptions for encryption get to use these encrypted links, while UEs that do not have the user subscriptions for the encryption do not get to use these encrypted links.

UE 501 registers with AMF 508 over 5G NR AN 502. AMF 508 retrieves subscriber information for UE 501 from user data system 509. The subscriber information indicates a default bearer between UE 501 and P-CSCF 521. AMF 508 obtains policy for UE 501 from PCF 810 (PCF 508 is not shown on FIG. 15). AMF 508 and SMF 511 process the subscriber information and policy to develop UE context. AMF 508 transfers the UE context to 5G NR AN 502. SMF 511 transfers the UE context to UPF 512. AMF 508 transfers the UE context to UE 501 over 5G NR AN 502. The default bearer traverses 5G NR AN 502 and UPF 512. UE 501 registers with P-CSCF 521 over the default bearer. P-CSCF 521 notifies S-CSCF 522 of UE 501. S-CSCF 522 retrieves subscriber information for UE 501 from user data system 509. The subscriber information indicates a user subscription for encrypted user messages and cryptography instructions for UE 501. S-CSCF 522 indicates the cryptography instructions for UE 501 to P-CSCF 521 and to SMGW 525. In response to the cryptography instructions, P-CSCF 521 and UE 501 exchange cryptography data to establish SIP encryption over the default bearer that traverses UPF 512 and 5G NR AN 502.

To transfer the user message, UE 501 transfers an encrypted SIP message that carries the user message to P-CSCF 521 over the default bearer. P-CSCF 521 decrypts and processes the SIP message. P-CSCF 521 encrypts and transfers the SIP message to S-CSCF 522. S-CSCF 522 decrypts and processes the SIP message. S-CSCF 523 encrypts and transfers the SIP message to SMGW 525. SMGW 525 decrypts and processes the SIP message. SMGW 525 encrypts and transfers the SIP message to IMS 532. IMS 532 decrypts and processes the SIP message. IMS 532 encrypts and transfers the SIP message to UE 531. UE 531 decrypts and presents the user message.

UPF 512 determines default bearer usage for the user message and transfers the usage information to SMF 511. The bearer usage indicates UE 501, date and time, and amount of SIP messaging over the default bearer. SMF 511 generates a rough CDR based on the bearer usage. SMF 511 transfers the rough CDR to CHF 513. SMGW 525 determines cryptography usage for the user message. The cryptography usage indicates UE 501, UE 531, date and time, and encryption details. SMGW 525 generates a rough CDR based on the cryptography usage. SMGW 525 transfers the rough CDR to CHF 513. CHF 513 merges the CDRs into a single CDR that indicates bearer usage and cryptography usage for the user message. CHF 513 transfers the CDR to a billing system (not shown).

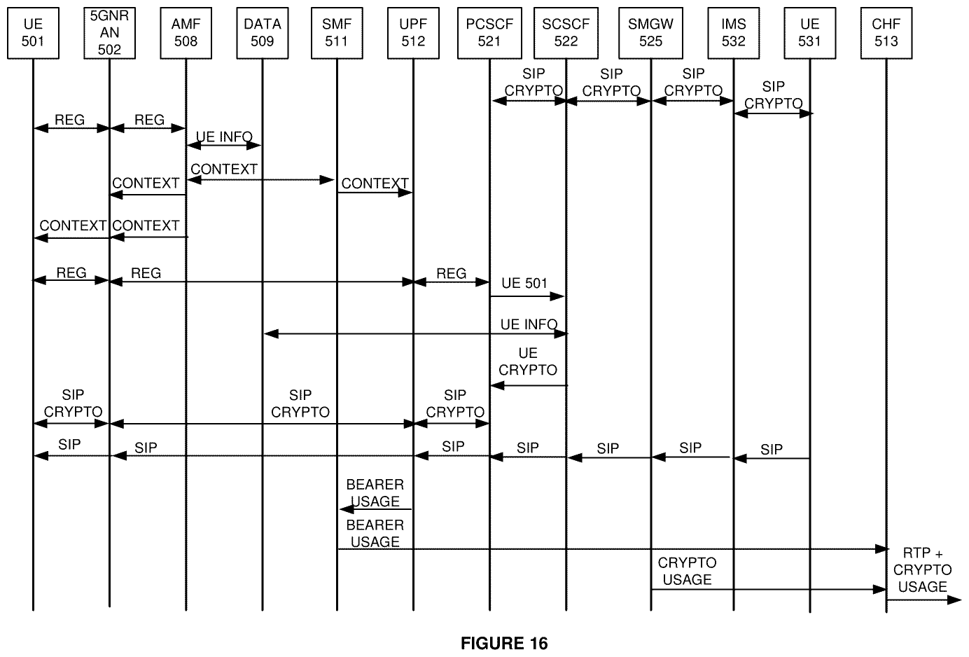

FIG. 16 illustrates an exemplary operation of wireless communication network 500 to encrypt the user data and the session signaling for a user message from UE 531 to UE 501 based on a user subscription for the encryption. The operation may differ in other examples. Initially, P-CSCF 521 and S-CSCF 522 exchange cryptography information to establish an encrypted SIP link. S-CSCF 522 and SMGW 525 exchange cryptography information to establish an encrypted SIP link. SMGW 525 and IMS 532 exchange cryptography information to establish an encrypted SIP link. IMS 532 and UE 531 exchange cryptography information to establish an encrypted SIP link. UEs with user subscriptions for encryption get to use these encrypted links, while UEs that do not have the user subscriptions for the encryption do not get to use these encrypted links.

UE 501 registers with AMF 508 over 5G NR AN 502. AMF 508 retrieves subscriber information for UE 501 from user data system 509. The subscriber information indicates a default bearer between UE 501 and P-CSCF 521. AMF 508 obtains policy for UE 501 from PCF 810 (PCF 819 is not shown on FIG. 15). AMF 508 and SMF 511 process the subscriber information and policy to develop UE context. AMF 508 transfers the UE context to 5G NR AN 502. SMF 511 transfers the UE context to UPF 512. AMF 508 transfers the UE context to UE 501 over 5G NR AN 502. The default bearer traverses 5G NR AN 502 and UPF 512. UE 501 registers with P-CSCF 521 over the default bearer. P-CSCF 521 notifies S-CSCF 522 of UE 501. S-CSCF 522 retrieves subscriber information for UE 501 from user data system 509. The subscriber information indicates a user subscription for encrypted user messages and the cryptography instructions for UE 501. S-CSCF 522 indicates the cryptography instructions for UE 501 to P-CSCF 521 and SMGW 525. In response to the cryptography instructions, P-CSCF 521 and UE 501 exchange cryptography data to establish SIP encryption over the default bearer that traverses UPF 512 and 5G NR AN 502.

UE 531 transfers an encrypted SIP message that carries the user message to IMS 532. IMS 532 transfers the encrypted SIP message to SMGW 525. SMGW 525 receives the encrypted SIP message for UE 501 from IMS 532. SMGW 525 decrypts and processes the SIP message. SMGW 525 encrypts and transfers the SIP message to S-CSCF 522. S-CSCF 522 decrypts and processes the SIP message. S-CSCF 522 encrypts and transfers the SIP message to P-CSCF 521. P-CSCF 521 decrypts and processes the SIP message. P-CSCF 521 encrypts and transfers the SIP message to UE 501 over the default bearer. UE 501 decrypts the SIP message and presents the user message.

UPF 512 determines network usage for the call and transfers the usage information to SMF 511. The network usage data indicates UE 501, date and time, and amount of SIP messaging. SMF 511 generates a rough CDR based on the network usage data. SMF 511 transfers the rough CDR to CHF 513. SMGW 525 determines cryptography usage for the user message and transfers cryptography usage information to CHF 513. The cryptography usage information indicates UE 501, UE 531, date and time, and encryption details. SMGW 525 generates a rough CDR based on the cryptography usage information. SMGW 525 transfers the rough CDR to CHF 513 or to a billing system (not shown) where the CDRs are merged into a single CDR that indicates network usage and cryptography usage for the user message.

Advantageously, wireless communication network 500 delivers an individual cryptographic service to UE 501 and generates CDRs for the cryptography service. The excessive cost of providing this cryptographic service to all UEs is avoided. The CDRs enable the collection of value from the subscribing users of the cryptographic service. This collected value can fund further development and growth of the cryptographic service.

The wireless communication system circuitry described above comprises computer hardware and software that form special-purpose data communication circuitry to encrypt user data based on a user subscription for encryption. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to encrypt user data based on a user subscription for encryption.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
receiving a first message from a user communication device that requests a user data session, and in response, determining that the user communication device has a user subscription for encrypted communications;
in response to determining that the user communication device has the user subscription for the encrypted communications, determining cryptography information for the user data session;
generating and transferring a second message to the user communication device that indicates the cryptography information for the user data session, wherein the user communication device encrypts user data in response to the cryptography information and transfers the encrypted user data for the user data session; and
generating and transferring a usage record for the user subscription that characterizes the user data session and the user data encryption.

2. The method of claim 1 wherein the user communication device exchanges cryptography messages with another user communication device to establish the encryption in response to the cryptography information, wherein the encryption uses one of Secure Realtime Transfer Protocol (SRTP) and Message Session Relay Protocol (MSRP).

3. The method of claim 1 wherein:
receiving the first message from the user communication device comprises receiving a first Session Initiation Protocol (SIP) message; and
generating and transferring the second message to the user communication device comprises generating and transferring a second SIP message.

4. The method of claim 1 wherein determining the cryptography information for the data communication comprises exchanging Session Initiation Protocol (SIP) messages with an Internet Protocol Multimedia Subsystem (IMS) to develop the cryptography information.

5. The method of claim 1 wherein:
determining the cryptography information comprises determining a network address for another user; and
generating and transferring the second message to the user communication device that indicates the cryptography information comprises generating and transferring the second message to the user communication device that indicates network address, wherein the user communication device uses the network address to establish the encryption.

6. The method of claim 1 wherein:
determining the cryptography information comprises determining an encryption protocol; and
generating and transferring the second message to the user communication device that indicates the cryptography information comprises generating and transferring the second message to the user communication device that indicates the encryption protocol, wherein the user communication device uses the encryption protocol for the encryption.

7. The method of claim 1 further comprising:
developing additional cryptography information for Session Initiation Protocol (SIP) signaling in response to the user subscription for the encrypted communications;
transferring the additional cryptography information to the user communication device, wherein the user communication device exchanges additional cryptography messages with an Internet Protocol Multimedia Subsystem (IMS) to establish the encryption of the SIP signaling in response to the additional cryptography information;
encrypting the SIP signaling transferred to the user communication device in response to the additional cryptography information and decrypting the SIP signaling from the user communication device in response to the additional cryptography information; and wherein generating and transferring the usage record comprises generating and transferring the usage record that characterizes the user data session, the user data encryption, and the SIP signaling encryption.

8. A non-transitory computer-readable media that stores processing instructions to direct a computer system to perform the following method when the computer system executes the processing instructions, the method comprising:
processing an Internet Multimedia Subsystem (IMS) request from a user for a data communication;
determining that the user has a user subscription for encrypted communications and responsively determining cryptography information for the data communication;
generating an IMS response for the user that indicates the cryptography information, wherein the user encrypts user data for the data communication in response to the cryptography information; and
generating a usage record for the user subscription for the encrypted communications that characterizes the encryption of the user data.

9. The non-transitory computer-readable media of claim 8 wherein:
determining the cryptography information comprises determining a network address for another user on the data communication; and
generating the IMS response for the user that indicates the cryptography information comprises generating the IMS response for the user that indicates the network address, wherein the user uses the network address to establish the encryption.

10. The non-transitory computer-readable media of claim 8 wherein:
determining the cryptography information comprises determining an encryption protocol for the data communication; and
generating the IMS response for the user that indicates the cryptography information comprises generating the IMS response for the user that indicates the encryption protocol, wherein the user uses the encryption protocol for the encryption.

11. The non-transitory computer-readable media of claim 8 wherein the data communication comprises one of an encrypted voice call, encrypted video call, and encrypted user data message.

12. The non-transitory computer-readable media of claim 8 wherein the user exchanges cryptography messages with another user to establish the encryption in response to the cryptography information.

13. The non-transitory computer-readable media of claim 8 wherein determining the cryptography information for the data communication comprises exchanging signaling with another IMS.

14. The non-transitory computer-readable media of claim 8 further comprising:
developing additional cryptography information for IMS signaling in response to the user subscription for the encrypted communications;
transferring the additional cryptography information to the user, wherein the user exchanges cryptography messages with another user to establish the encryption in response to the cryptography information;
encrypting the IMS signaling transferred to the user in response to the additional cryptography information and decrypting the IMS signaling from the user in response to the additional cryptography information; and
generating the usage record comprises generating the usage record that characterizes the encryption of the user data and that characterizes the encryption of the IMS signaling.

15. A data communication system comprising:
a Session Initiation Protocol (SIP) system to receive a first Session Initiation Protocol (SIP) message from a user communication device, and in response, determine that the user communication device has a user subscription for encrypted communications;
in response to determining that the user communication device has the user subscription for the encrypted communications, the SIP system to determine cryptography information;
the SIP system to generate and transfer a second SIP message to the user communication device that indicates the cryptography information, wherein the user communication device encrypts user data for the data communication in response to the cryptography information; and
an application server to generate and transfer a usage record that characterizes the encryption of the user data.

16. The data communication system of claim 15 wherein the user communication device is to exchange cryptography messages with another user communication device to establish the encryption in response to the cryptography information.

17. The data communication system of claim 15 wherein the SIP system is to exchange additional SIP messages with an Internet Protocol Multimedia Subsystem (IMS) to determine the cryptography information for the data communication.

18. The data communication system of claim 15 further comprising:
the SIP system to determine additional cryptography information for SIP signaling in response to the user subscription for the encrypted communications;
the SIP system to transfer the additional cryptography information to the user communication device, wherein the user communication device exchanges additional cryptography messages with an Internet Protocol Multimedia Subsystem (IMS) to establish encryption for SIP signaling in response to the additional cryptography information;
the SIP system to encrypt the SIP signaling transferred to the user communication device in response to the additional cryptography information and decrypt the SIP signaling from the user communication device in response to the additional cryptography information; and
the application server to generate the usage record to characterize the encryption of the user data and the encryption of the SIP signaling.

19. The data communication system of claim 15 wherein the SIP system comprises a Proxy Call Session Control Function (P-CSCF).

20. The data communication system of claim 15 wherein the SIP system is to retrieve subscriber information for the user communication device from one of a Uniform Data Repository (UDR) and a Home Subscriber System (HSS) to determine that the user communication device has the user subscription for the encrypted communications.
